(19) United States
(12) Patent Application Publication
(10) Pub. No.: US 2026/0067818 A1
(43) Pub. Date: Mar. 5, 2026

(54) TRANSMISSION PROCESSING METHOD AND APPARATUS, TERMINAL, AND NETWORK SIDE DEVICE

(71) Applicant: VIVO MOBILE COMMUNICATION CO., LTD., Dongguan (CN)

(72) Inventors: Dongru LI, Dongguan (CN); Xueming PAN, Dongguan (CN); Xin QU, Dongguan (CN)

(21) Appl. No.: 19/385,220

(22) Filed: Nov. 11, 2025

Related U.S. Application Data
(63) Continuation of application No. PCT/CN2024/091554, filed on May 8, 2024.

(30) Foreign Application Priority Data
May 15, 2023 (CN) 2023105425971

(51) Int. Cl. H04W 52/02; H04L 5/00; H04W 76/28

(52) U.S. Cl. CPC H04W 52/0235; H04L 5/0044; H04W 76/28

(57) ABSTRACT

A transmission processing method and apparatus, a terminal, and a network side device are disclosed in the field of communications technologies. The transmission processing method includes as follows. A terminal performs at least one of a first operation and a second operation, where the first operation includes performing a first behavior or a second behavior according to a measurement result of a first signal, and the second operation includes performing the second behavior when a first timer expires; where the first behavior includes entering monitoring of a wake-up signal, or entering monitoring of a wake-up signal and do not monitoring target content; the second behavior includes at least one of exiting monitoring of the wake-up signal and resuming monitoring of the target content; and the target content includes at least one of a PDCCH, a PDSCH, and a downlink RS.

### CROSS-REFERENCE TO RELATED APPLICATIONS

This application is a bypass continuation application of International Application No. PCT/CN2024/091554, filed on May 8, 2024, which claims the benefit of and priority to Chinese Patent Application No. 202310542597.1, filed on May 15, 2023, the contents of both of which being incorporated by reference in their entireties herein.

### TECHNICAL FIELD

This application relates to the field of communications technologies and, more specifically, relates to a transmission processing method and apparatus, a terminal, and a network side device.

### BACKGROUND

With the development of mobile communications, low-power wake-up receivers (LP-WURs) have been introduced into mobile terminals to receive low-power wake-up signals (LP-WUSs). This allows the main communication module to remain turned off or in a sleep state, thereby reducing power consumption of the terminal. However, if LP-WUS reception performance is poor, the terminal may fail to receive the wake-up signal and therefore cannot be activated for normal data transmission, resulting in degraded communication performance.

### BRIEF SUMMARY

Embodiments of this application provide a transmission processing method and apparatus, a terminal, and a network side device.

According to a first aspect, a transmission processing method is provided. The method includes:

A terminal performs at least one of a first operation and a second operation, where the first operation includes performing a first behavior or a second behavior according to a measurement result of a first signal, and the second operation includes performing the second behavior when a first timer expires; where

the first behavior includes entering monitoring of a wake-up signal, or entering monitoring of a wake-up signal and do not monitoring target content; the second behavior includes at least one of exiting monitoring of the wake-up signal and resuming monitoring of the target content; and the target content includes at least one of a physical downlink control channel PDCCH, a physical downlink shared channel PDSCH, and a downlink reference signal.

According to a second aspect, a transmission processing method is provided. The method includes:

A network side device performs a target operation according to a target measurement result or target uplink transmission, where the target operation includes a third behavior or a fourth behavior;

the target measurement result includes a measurement result of a first signal reported by a terminal, or a measurement result of a second signal obtained by the network side device through measurement, the third behavior includes at least one of beginning transmission of a wake-up signal and suspending transmission of target content, and the fourth behavior includes at least one of the following: suspending or stopping transmission of the wake-up signal and resuming transmission of the target content; and

the target content includes at least one of a physical downlink control channel PDCCH, a physical downlink shared channel PDSCH, and a downlink reference signal.

According to a third aspect, a transmission processing apparatus is provided. The apparatus includes:

a first performing module, configured to perform at least one of a first operation and a second operation, where the first operation includes performing a first behavior or a second behavior according to a measurement result of a first signal, and the second operation includes performing the second behavior when a first timer expires; where

the first behavior includes entering monitoring of a wake-up signal, or entering monitoring of a wake-up signal and do not monitoring target content; the second behavior includes at least one of exiting monitoring of the wake-up signal and resuming monitoring of the target content; and the target content includes at least one of a physical downlink control channel PDCCH, a physical downlink shared channel PDSCH, and a downlink reference signal.

According to a fourth aspect, a transmission processing apparatus is provided. The apparatus includes:

a second performing module, configured to perform a target operation according to a target measurement result or target uplink transmission, where the target operation includes a third behavior or a fourth behavior;

the target measurement result includes a measurement result of a first signal reported by a terminal, or a measurement result of a second signal obtained by the network side device through measurement, the third behavior includes at least one of beginning transmission of a wake-up signal and suspending transmission of target content, and the fourth behavior includes at least one of the following: suspending or stopping transmission of the wake-up signal and resuming transmission of the target content; and

the target content includes at least one of a physical downlink control channel PDCCH, a physical downlink shared channel PDSCH, and a downlink reference signal.

According to a fifth aspect, a terminal is provided. The terminal includes a processor and a memory. The memory stores a program or an instruction that is executable on the processor, and the program or the instruction is executed by the processor to implement the steps of the method according to the first aspect.

According to a sixth aspect, a terminal is provided. The terminal includes a processor and a communication interface. The communication interface is configured to perform at least one of a first operation and a second operation, where the first operation includes performing a first behavior or a second behavior according to a measurement result of a first signal, and the second operation includes performing the second behavior when a first timer expires; where

the first behavior includes entering monitoring of a wake-up signal, or entering monitoring of a wake-up signal and do not monitoring target content; the second behavior includes at least one of exiting monitoring of the wake-up signal and resuming monitoring of the target content; and the target content includes at least one of a physical downlink control channel PDCCH, a physical downlink shared channel PDSCH, and a downlink reference signal.

According to a seventh aspect, a network side device is provided. The network side device includes a processor and a memory, the memory stores a program or an instruction that is executable on the processor, and the program or the instruction is executed by the processor to implement the steps of the method according to the second aspect.

According to an eighth aspect, a network side device is provided. The network side device includes a processor and a communication interface. The communication interface is configured to perform a target operation according to a target measurement result or target uplink transmission, where the target operation includes a third behavior or a fourth behavior;

the target measurement result includes a measurement result of a first signal reported by a terminal, or a measurement result of a second signal obtained by the network side device through measurement, the third behavior includes at least one of beginning transmission of a wake-up signal and suspending transmission of target content, and the fourth behavior includes at least one of the following: suspending or stopping transmission of the wake-up signal and resuming transmission of the target content; and

the target content includes at least one of a physical downlink control channel PDCCH, a physical downlink shared channel PDSCH, and a downlink reference signal.

According to a ninth aspect, a readable storage medium is provided. The readable storage medium stores a program or an instruction, and when the program or the instruction is executed by a processor, the steps of the method according to the first aspect are implemented, or the steps of the method according to the second aspect are implemented.

According to a tenth aspect, a wireless communication system is provided, and includes a terminal and a network side device. The terminal may be configured to perform the steps of the method according to the first aspect, and the network side device may be configured to perform the steps of the method according to the second aspect.

According to an eleventh aspect, a chip is provided. The chip includes a processor and a communication interface, the communication interface is coupled to the processor, and the processor is configured to run a program or an instruction to implement the method according to the first aspect or the method according to the second aspect.

According to a twelfth aspect, a computer program/program product is provided. The computer program/program product is stored in a storage medium, and the program/program product is executed by at least one processor to implement the method according to the first aspect or implement the method according to the second aspect.

### BRIEF DESCRIPTION OF DRAWINGS

FIG. 1 is a schematic diagram of a network structure to which embodiments of this application may be applied;

FIG. 2 is a diagram of a terminal wake-up principle according to an embodiment of this application;

FIG. 3 is a schematic flowchart of a waveform of a wake-up signal according to an embodiment of this application;

FIG. 4 is a first schematic flowchart of a transmission processing method according to an embodiment of this application;

FIG. 5 is a second schematic flowchart of a transmission processing method according to an embodiment of this application;

FIG. 6 is a third schematic flowchart of a transmission processing method according to an embodiment of this application;

FIG. 7 is a fourth schematic flowchart of a transmission processing method according to an embodiment of this application;

FIG. 8 is a fifth schematic flowchart of a transmission processing method according to an embodiment of this application;

FIG. 9 is a schematic diagram of a structure of a transmission processing apparatus according to an embodiment of this application;

FIG. 10 is a schematic diagram of a structure of another transmission processing apparatus according to an embodiment of this application;

FIG. 11 is a schematic diagram of a structure of a communication device according to an embodiment of this application;

FIG. 12 is a schematic diagram of a structure of a terminal according to an embodiment of this application; and

FIG. 13 is a schematic diagram of a structure of a network side device according to an embodiment of this application.

### DETAILED DESCRIPTION

Terms such as "first" and "second" in this application are used to distinguish between similar objects, and are not used to describe a specific order or sequence. It should be understood that, the terms used in such a way are interchangeable in proper circumstances, so that the embodiments of this application can be implemented in an order other than the order illustrated or described herein. Objects classified by "first" and "second" are usually of a same type, and a quantity of objects is not limited. For example, there may be one or more first objects. In addition, "or" in this application means at least one of the connected objects. For example, "A or B" includes three solutions, namely: solution 1: include A but exclude B; solution 2: include B but exclude A; solution 3: include both A and B. The character "/" usually indicates an "or" relationship between the associated objects.

The term "indication" in this application may be a direct indication (or explicit indication) or an indirect indication (or implicit indication). The direct indication may be understood as that a sender explicitly notifies a sent indication of content such as specific information, an operation that needs to be performed, or a request result to a receiver. The indirect indication may be understood as that the receiver determines corresponding information according to the indication sent by the sender, or performs determining according to the indication sent by the sender, and determines, according to a determining result, the operation that needs to be performed, the request result, or the like.

It should be noted that technologies described in the embodiments of this application are not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), single-carrier frequency-division multiple access (SC-FDMA), or other systems. The terms "system" and "network" in the embodiments of this application may be used interchangeably. The technologies described can be applied to both the systems and the radio technologies mentioned above as well as to other systems and radio technologies. A new radio (NR) system is described in the following descriptions for illustrative purposes, and the NR terminology is used in most of the following descriptions, although these technologies can also be applied to a system other than the NR system, such as a 6^{th} generation (6G) communication system.

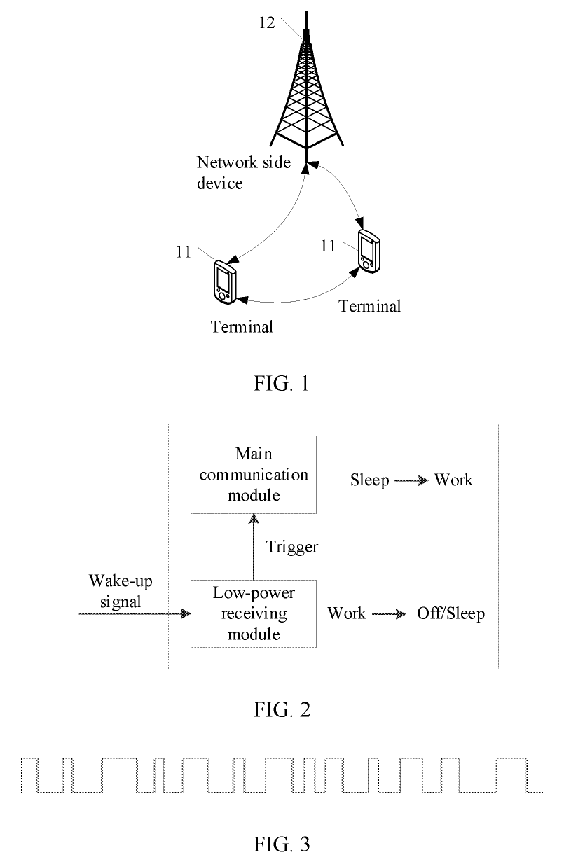

FIG. 1 is a block diagram of a wireless communication system to which the embodiments of this application may be applied. The wireless communication system includes a terminal 11 and a network side device 12. The terminal 11 may be a terminal side device such as a mobile phone, a tablet personal computer, a laptop computer, a notebook computer, a personal digital assistant (PDA), a palmtop computer, a netbook, an ultra-mobile personal computer (UMPC), a mobile internet device (MID), an augmented reality (AR) device, a virtual reality (VR) device, a robot, a wearable device, a flight vehicle, vehicle user equipment (VUE), ship user equipment, pedestrian user equipment (PUE), a smart home (a home device with a wireless communication function, such as a refrigerator, a television, a washing machine, or a furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, a smart chain, and the like), a smart wrist strap, a smart dress, and the like. The vehicle user equipment may also be referred to as a vehicle terminal, a vehicle controller, a vehicle module, a vehicle component, a vehicle chip, a vehicle unit, or the like. It should be noted that a specific type of the terminal 11 is not limited in the embodiments of this application. The network side device 12 may include an access network device or a core network device. The access network device may also be referred to as a radio access network (RAN) device, a radio access network function, or a radio access network unit. The access network device may include a base station, a wireless local area network (WLAN) access point (AS), wireless fidelity (WiFi) node, or the like. The base station may be referred to as a NodeB (NB), an evolved NodeB (eNB), a next generation NodeB (gNB), a new radio NodeB (NR NodeB), an access point, a relay base station (RBS), a serving base station (SBS), a base transceiver station (BTS), a radio base station, a radio transceiver, a basic service set (BSS), an extended service set (ESS), a home NodeB (HNB), a home evolved NodeB, a transmission reception point (TRP), or another appropriate term in the field. Provided that a same technical effect is achieved, the base station is not limited to a specified technical term. It should be noted that, in the embodiments of this application, only a base station in an NR system is used as an example for description, and a specific type of the base station is not limited.

For ease of understanding, some content involved in the embodiments of this application is described below.

### 1. Low-power receiver

The low-power receiver may be referred to as an LP-WUR or an almost zero power wake-up receiver (AZP-WUR). A basic working principle of the LP-WUR is that a receiving end includes a first module and a second module. The first module is a main communication module, configured to send and receive mobile communication data. The second module is a low-power receiving module (also referred to as a low-power wake-up receiving module), configured to receive the wake-up signal. Specifically, as shown in FIG. 2, a terminal turns on the low-power receiving module in an energy-saving state to monitor an LP-WUS and turns off the main communication module. When downlink data arrives, a network side device sends the wake-up signal to the terminal. After monitoring the wake-up signal through the low-power receiving module, the terminal performs a series of determining to trigger the main communication module to switch from off to on. In this case, the low-power receiving module enters from a working state to an off state. The low-power wake-up receiving module may be continuously turned on or intermittently turned on; and when turned on, may receive the low-power wake-up signal.

### 2. Low-power wake-up signal (LP-WUS)

To reduce a receiving activity of the terminal in a standby state, so that radio frequency (RF) and baseband (MODEM) modules are actually turned off to greatly reduce power consumption of communication reception, this can be achieved by introducing an almost "zero" power receiver into the receiving module of the terminal. The almost "zero" power receiver does not need complex RF module signal detection (such as amplification, filtering, quantization, and the like) and MODEM signal processing, and only relies on passively matching filtering and signal processing with low power consumption.

On a base station side, the wake-up signal is triggered on demand, and the almost "zero" power receiver may be activated to learn of an activation notification, so as to trigger a series of procedures inside the terminal, for example, turning on radio frequency transceiver and baseband processing modules, and the like.

This type of wake-up signals are usually some simple on-off keying signals. A time-domain pattern of the on-off keying signal is shown in FIG. 3. In this way, the receiver may learn of a wake-up notification through simple energy detection, subsequent possible sequence detection identification, and other processes. Furthermore, when the terminal turns on the low-power wake-up receiver to receive the wake-up signal, the main receiver module may remain working at a low power consumption level, to reduce power consumption by receiving the wake-up signal.

Receiving of the low-power wake-up signal may be applied to a terminal in a radio resource control (RRC) idle (RRC_idle)/inactive state, or may be applied to a terminal in an RRC connected (RRC_connected) state, to implement energy-saving of the terminal.

In an embodiment, the wake-up signal mentioned in this application is the wake-up signal received by the low-power receiver.

In an embodiment, in the RRC connected state, a low-power synchronization reference signal (LP-SS) cannot be applied. The LP-SS is applied in the RRC idle/inactive state and is used by the low-power receiver for synchronization and/or measurement. The LP-WUS and the LP-SS are both received by the low-power receiver. Because the terminal cannot receive the LP-SS for synchronization and/or measurement in the RRC connected state, the terminal in the connected state can receive an existing reference signal such as an SSB or a CSI-RS through only the main communication module, to measure and estimate receiving performance of the LP-WUS.

With reference to the accompanying drawings, a transmission processing method provided in the embodiments of this application is described in detail by using some embodiments and application scenarios.

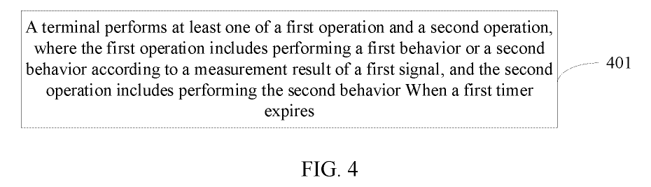

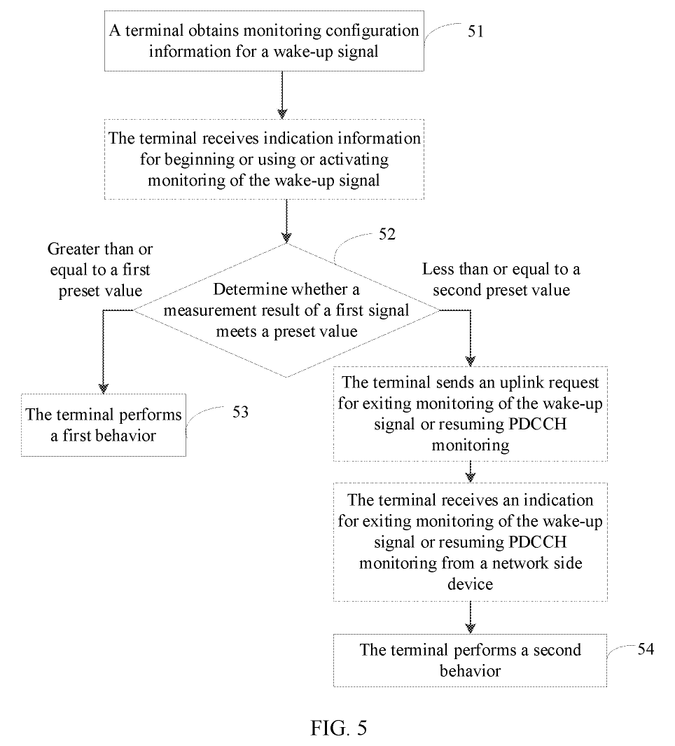

Refer to FIG. 4. An embodiment of this application provides a transmission processing method. As shown in FIG. 4, the transmission processing method includes the following steps:

Step 401: A terminal performs at least one of a first operation and a second operation, where the first operation includes performing a first behavior or a second behavior according to a measurement result of a first signal, and the second operation includes performing the second behavior when a first timer expires.

The first behavior includes entering monitoring of a wake-up signal, or entering monitoring of a wake-up signal and do not monitoring target content; the second behavior includes at least one of exiting monitoring of the wake-up signal and resuming monitoring of the target content; and the target content includes at least one of a physical downlink control channel (PDCCH), a physical downlink shared channel (PDSCH), and a downlink reference signal.

In this embodiment of this application, entering monitoring of the wake-up signal may be understood as activating monitoring of the wake-up signal or beginning monitoring of the wake-up signal. Similarly, exiting monitoring of the wake-up signal may be understood as deactivating monitoring of the wake-up signal or not monitoring the wake-up signal.

Optionally, specific content of the measurement result may be set according to an actual requirement. For example, in some embodiments, the measurement result may include at least one of a reference signal received power (RSRP), reference signal received quality (RSRQ), and a signal to interference plus noise ratio (SINR). For example, the measurement result is a layer 1 SINR.

For the first operation, the first signal may be understood as a downlink signal. The terminal may determine current network communication quality according to the measurement result of the first signal. The terminal may enter monitoring of the wake-up signal when the network communication quality is good, and the wake-up signal is applied to reduce power consumption of the terminal. The terminal may exit monitoring of the wake-up signal and may perform or resume monitoring of the target content when the network communication quality is poor, to avoid a case that the terminal fails to receive the wake-up signal and therefore cannot be woken up for normal data transmission. Therefore, communication reliability can be improved.

For the second operation, the first timer may be configured by the network side device or agreed upon in a protocol. By using the first timer, because the first timer is configured, the terminal may exit monitoring of the wake-up signal when the first timer expires, and may perform or resume monitoring of the target content, to avoid a case that the terminal fails to receive the wake-up signal and therefore cannot be woken up for normal data transmission. Therefore, communication reliability can be improved.

In the embodiments of this application, the terminal performs at least one of the first operation and the second operation, where the first operation includes performing the first behavior or the second behavior according to the measurement result of the first signal, and the second operation includes performing the second behavior when the first timer expires; where the first behavior includes entering monitoring of the wake-up signal, or entering monitoring of the wake-up signal and do not monitoring the target content; the second behavior includes at least one of exiting monitoring of the wake-up signal and resuming monitoring of the target content; and the target content includes at least one of the physical downlink control channel PDCCH, the physical downlink shared channel PDSCH, and the downlink reference signal. In this way, the terminal may perform at least one of the operation behaviors: exiting monitoring of the wake-up signal and resuming monitoring of the target content based on the target measurement result and the first timer, to avoid a problem that the terminal cannot be woken up for normal data transmission due to an incapability to receive the wake-up signal. Therefore, the embodiments of this application improve communication reliability.

Optionally, in some embodiments, when the target content includes the PDCCH, resuming PDCCH monitoring includes at least one of the following:

performing PDCCH monitoring by using a target discontinuous reception (DRX) configuration;

performing PDCCH monitoring according to a target search space group; and

performing PDCCH monitoring from N^{th} time unit starting from a time unit in which the terminal sends target uplink transmission, where N is a natural number, and the target uplink transmission is uplink information or an uplink signal.

For example, the target uplink transmission is used to at least one of notify network channel quality, notify that network channel quality declines and is lower than a preset value, or request, from a network, to exit monitoring of the wake-up signal or resume monitoring of the target content, and so on. The terminal begins to resume PDCCH monitoring after an interval of N time units starting from the time unit in which the target uplink transmission is sent. For example, the N time units may be N slots or N milliseconds. A value of N may be 0. In other words, the terminal performs PDCCH monitoring at a start time of a next time unit in which the target uplink transmission is sent.

In this embodiment of this application, performing PDCCH monitoring according to the target search space group may be understood as performing PDCCH monitoring by using the target search space group, or may be understood as performing PDCCH monitoring in the target search space group.

Optionally, the time unit may be a slot, a sub-slot, a frame, or a sub-frame. No further limitation is imposed herein.

Optionally, in some embodiments, the target DRX configuration may be agreed upon in the protocol or configured by the network side device. No further limitation is imposed herein.

Optionally, in some embodiments, the target DRX configuration is in an activated state when the terminal performs the second behavior.

Because the target DRX configuration is in the activated state in the case that the terminal performs the second behavior, the terminal may perform PDCCH monitoring by using the target DRX configuration.

Optionally, in some embodiments, the performing PDCCH monitoring by using a target discontinuous reception DRX configuration includes:

starting a second timer associated with the target DRX configuration, and performing, by the terminal, PDCCH monitoring during the running of the second timer.

In this embodiment of this application, the second timer may be a DRX-related timer in the target DRX configuration, for example, may be a DRX inactivity timer (drx-inactivitytimer); for another example, may be a DRX on-duration timer (ondurationtimer).

Optionally, in some embodiments, when the terminal performs the first operation, the method further includes:

The terminal sends target uplink transmission to a network side device, where the target uplink transmission is uplink information or an uplink signal, and the target uplink transmission includes at least one of the following: first information or second information, a measurement report, and a target reference signal; and

the first information is used to request or inform at least one of the following: exiting monitoring of the wake-up signal and resuming monitoring of the target content; and the second information is used to request or inform at least one of the following: entering monitoring of the wake-up signal, and entering monitoring of the wake-up signal and do not monitoring the target content.

In this embodiment of this application, the measurement report may include a channel state information (CSI) report, a layer 1 (L1) reference signal received power (L1-RSRP) report, an L1-SINR report, and the like.

Optionally, the target reference signal is a sounding reference signal (Sounding Reference Signal, SRS).

In some embodiments, the terminal may include the first information or the second information in the SRS. After receiving the first information or the second information, the network side device measures the SRS to further determine whether to indicate the terminal to at least one of exit WUS monitoring and resume PDCCH monitoring.

Optionally, when the network side device receives the first information from the terminal, the network side device performs at least one of the following: sending WUS monitoring indication information (for example, sending an indication for suspending or stopping WUS monitoring), suspending or stopping sending the WUS to the terminal, and deactivating or disabling a WUS monitoring configuration associated with the terminal.

Optionally, when the terminal determines to enter LP-WUS monitoring, the terminal sends a WUS monitoring beginning notification to the network side device.

It should be understood that the terminal may request, from the network side device, to exit WUS monitoring without performing a handshake with the network side device (the handshake means sending a notification and receiving confirmation information). However, the terminal re-enters WUS monitoring, and whether the network side device further indicates the terminal to enter WUS monitoring or the terminal requests, from the network side device, to re-enter WUS monitoring needs to perform a handshake with the network side device (that is, the terminal needs to receive confirmation information for entering WUS monitoring from the network side device). After confirmation, the network side device sends the WUS to the terminal.

Optionally, in some embodiments, the first information or the second information is carried based on at least one of the following: a scheduling request (SR), a physical uplink control channel (PUCCH), a configured grant physical uplink shared channel (CG PUSCH), a buffer status report (BSR), uplink control information (UCI), channel state information CSI, and a physical random access channel (PRACH).

Optionally, in some embodiments, the terminal may determine, based on whether the measurement result of the first signal satisfies the preset value, to perform the first behavior or the second behavior. For example, in this embodiment of this application, the first operation satisfies at least one of the following:

when the measurement result of the first signal is greater than or equal to a first preset value, performing the first behavior; and

when the measurement result of the first signal is less than or equal to a second preset value, performing the second behavior, where

the first preset value is greater than or equal to the second preset value.

Optionally, the first preset value and the second preset value may be configured by the network side device or agreed upon in a protocol.

Optionally, in some embodiments, the method further includes:

The terminal sends the measurement result of the first signal to the network side device.

It should be noted that the network side device may determine, based on the reported measurement result, whether the preset value is met (applicable to a case that measurement is performed based on a downlink reference signal) or the network side device may determine, based on the measured measurement result, whether the preset value is met (applicable to a case that measurement is performed based on an uplink reference signal), and determine at least one of whether to perform WUS transmission and whether to resume PDCCH transmission.

In an embodiment, when the measurement result is less than or equal to the second preset value, the terminal performs the second behavior. However, the terminal does not send a notification that the second behavior is performed to the network side device. Instead, the network side device may implicitly determine, based on the measurement result reported by the terminal, whether the current terminal performs the second behavior.

Optionally, in some embodiments, the first signal includes at least one of a synchronization signal block (Synchronization Signal and PBCH block, SSB), a channel state information reference signal (CSI-RS), a positioning reference signal (PRS), and a sounding reference signal.

Optionally, in some embodiments, the method further includes:

The terminal measures the first signal by using a main communication module, and obtains the measurement result of the first signal. The main communication module is different from a receiver through which the terminal receives the wake-up signal. Details are described in the low-power receiver in 1.

In this embodiment of this application, the measurement result of the first signal may be understood as a result of measurement performed by the main communication module of the terminal.

Optionally, in some embodiments, a start time for resuming monitoring of the target content is determined based on a time of exiting monitoring of the wake-up signal or a time of sending the first information to the network side device; where

the first information is used to request or inform at least one of the following: exiting monitoring of the wake-up signal and resuming monitoring of the target content.

In this embodiment of this application, the terminal may resume monitoring of the target content after a first time interval after exiting monitoring of the wake-up signal or sending the first information. The first time interval may be configured by the network side device or agreed upon in the protocol. In some embodiments, the first time interval may be 0.

Optionally, the time of exiting monitoring of the wake-up signal may be understood as an end moment of a time unit in which exiting of monitoring of the wake-up signal is located, or a start time of a next time unit of a time unit in which exiting of monitoring of the wake-up signal is located. The time of sending the first information to the network side device may be understood as a time unit of the time of sending the first information to the network side device, or an end moment of a time unit of the time of sending the first information to the network side device.

Optionally, in some embodiments, a start time for not monitoring the target content is determined based on a time of performing monitoring of the wake-up signal or a time of sending the second information to the network side device; where the second information is used to request or inform at least one of the following: entering monitoring of the wake-up signal, and entering monitoring of the wake-up signal and do not monitoring the target content.

In this embodiment of this application, the terminal may not monitor the target content (such as, skip PDCCH monitoring) after a second time interval after entering monitoring of the wake-up signal or sending the first information. The second time interval may be configured by the network side device or agreed upon in the protocol. In some embodiments, the second time interval may be 0.

In an embodiment, the terminal may resume monitoring of the target content at a start time of exiting monitoring of the wake-up signal, or the terminal resumes monitoring of the target content at an end moment of the time unit in which the first information is sent.

In an embodiment, the terminal may not monitor the target content at a start time of entering monitoring of the wake-up signal, or may not monitor the target content at an end moment of the time unit in which the second information is sent.

Optionally, the time of performing monitoring of the wake-up signal may be understood as a start time of the time unit in which monitoring of the wake-up signal is performed, or an end moment of the time unit in which monitoring of the wake-up signal is performed.

Optionally, in some embodiments, the method further includes:

The terminal monitors the wake-up signal during the running of the first timer; or

the terminal starts the first timer when the terminal begins to monitor the wake-up signal.

Optionally, in some embodiments, the method further includes at least one of the following:

The terminal restarts the first timer when the terminal detects the wake-up signal or detects a PDCCH monitoring skipping indication.

The terminal suspends or stops the first timer when the terminal detects the wake-up signal or detects the wake-up signal with wake-up indication.

Optionally, the wake-up signal is used to trigger the terminal to resume PDCCH monitoring. It may be understood that the terminal resumes monitoring of the target content when the terminal detects the wake-up signal or detects the wake-up signal with wake-up indication.

In this embodiment of this application, the PDCCH monitoring skipping indication may be understood as an indication for not monitoring the PDCCH or an indication for continuing monitoring the wake-up signal.

Optionally, the method further includes:

The terminal suspends or stops running of the first timer when the terminal performs the second behavior. In other words, when the terminal performs at least one of exiting monitoring of the wake-up signal and resuming monitoring of the target content, the terminal suspends or stops running of the first timer.

Optionally, in some embodiments, before the terminal performs at least one of the first operation and the second operation, the method further includes at least one of the following:

The terminal receives monitoring configuration information for the wake-up signal from the network side device.

The terminal receives indication information for beginning monitoring of the wake-up signal or indication information for activating monitoring of the wake-up signal from the network side device.

In this embodiment of this application, the monitoring configuration information for the wake-up signal may include a time-frequency resource, a periodicity, an offset, and the like for WUS monitoring.

Optionally, after receiving the monitoring configuration information for the wake-up signal from the network side device, the terminal begins to perform WUS monitoring.

Optionally, after receiving the monitoring configuration information for the wake-up signal from the network side device, and receiving indication information indicating to begin or use or activate monitoring of the wake-up signal, the terminal begins to perform WUS monitoring. In other words, after receiving the monitoring configuration information for the wake-up signal from the network side device, the terminal does not begin to perform WUS monitoring, but begins to perform WUS monitoring when the indication information for beginning or using or activating monitoring of the wake-up signal is received.

To better understand this application, some examples are used for description below.

In some embodiments, the terminal may determine a monitoring behavior according to a condition.

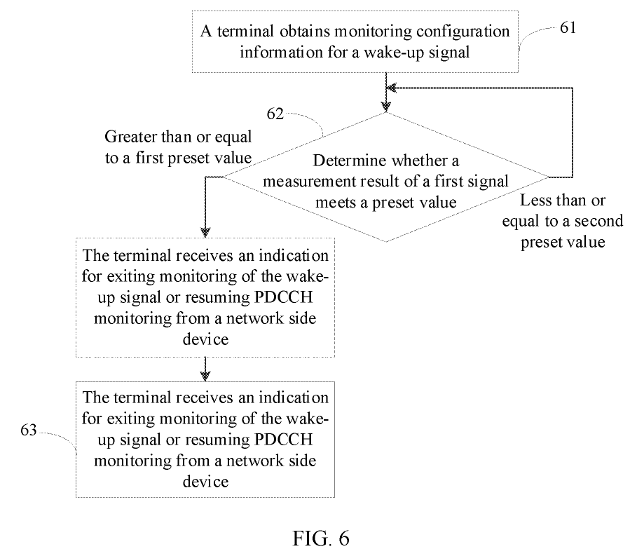

As shown in FIG. 5, in an embodiment, a transmission processing procedure includes the following procedure:

Step 51: A terminal obtains monitoring configuration information for a wake-up signal.

After step 51 and before step 52, 74 may be further included.

Step 52: Determine whether a measurement result of a first signal satisfies a preset value. The terminal may perform measurement according to the first signal and obtain the measurement result of the first signal. When the measurement result is greater than or equal to a first preset value, step 53 is performed. When the measurement result is less than or equal to a second preset value, step 54 is performed.

53: The terminal performs a first behavior. In other words, the terminal enters monitoring of the wake-up signal, or enters monitoring of the wake-up signal and does not monitor target content.

54: The terminal performs a second behavior. In other words, the terminal performs at least one of exiting monitoring of the wake-up signal and resuming monitoring of the target content.

Optionally, before step 54 is performed, the following procedure may be further included:

The terminal sends an uplink request for exiting monitoring of the wake-up signal or resuming PDCCH monitoring.

The terminal receives an indication for exiting monitoring of the wake-up signal or resuming PDCCH monitoring from a network side device.

As shown in FIG. 6, in an embodiment, a monitoring procedure of a terminal includes the following procedure:

Step 61: The terminal obtains monitoring configuration information for a wake-up signal. Optionally, the terminal does not enter monitoring of the wake-up signal.

Step 62: Determine whether a measurement result of a first signal satisfies a preset value. The terminal may perform measurement according to the first signal and obtain the measurement result of the first signal. When the measurement result is greater than or equal to a first preset value, step 63 is performed. When the measurement result is less than or equal to a second preset value, step 62 continues to be performed.

Step 63: The terminal performs a first behavior. In other words, the terminal enters monitoring of the wake-up signal, or enters monitoring of the wake-up signal and does not monitor target content.

Optionally, before step 63, the procedure may further include: The terminal receives an indication for exiting monitoring of the wake-up signal or resuming PDCCH monitoring from a network side device. When the indication for exiting monitoring of the wake-up signal or resuming PDCCH monitoring, step 63 is performed.

Optionally, in some embodiments, performing PDCCH monitoring by using a target discontinuous reception DRX configuration;

performing PDCCH monitoring according to a target search space group; and

performing PDCCH monitoring from N^{th} time unit starting from a time unit in which the terminal sends target uplink transmission, where N is a natural number, and the target uplink transmission is uplink information or an uplink signal.

Optionally, the target DRX configuration is configured by the network side device or agreed upon in a protocol. The target DRX configuration is in an activated state when the terminal performs a second behavior.

In this embodiment of this application, when the terminal determines that current channel quality is poor, the terminal determines to exit WUS monitoring and resume or fall back to a default PDCCH monitoring mode. In this embodiment, the terminal may fall back to a PDCCH monitoring mode of a connected discontinuous reception (CDRX) configuration. In an embodiment, the network side device pre-configures the fallback CDRX configuration. The fallback CDRX configuration is activated or applied when the terminal determines to perform the second behavior. The terminal performs PDCCH monitoring according to the fallback CDRX configuration, a CDRX cycle, and a CDRX timer.

In an embodiment, because a location at which the terminal determines to exit WUS monitoring does not fall within discontinuous reception duration (drx-onduration timer) in the fallback CDRX configuration, the terminal may fail to immediately resume PDCCH monitoring. To prevent this case, optionally, when the terminal exits WUS monitoring, drx-inactivity timer is started. Therefore, the terminal may resume PDCCH monitoring within the timer.

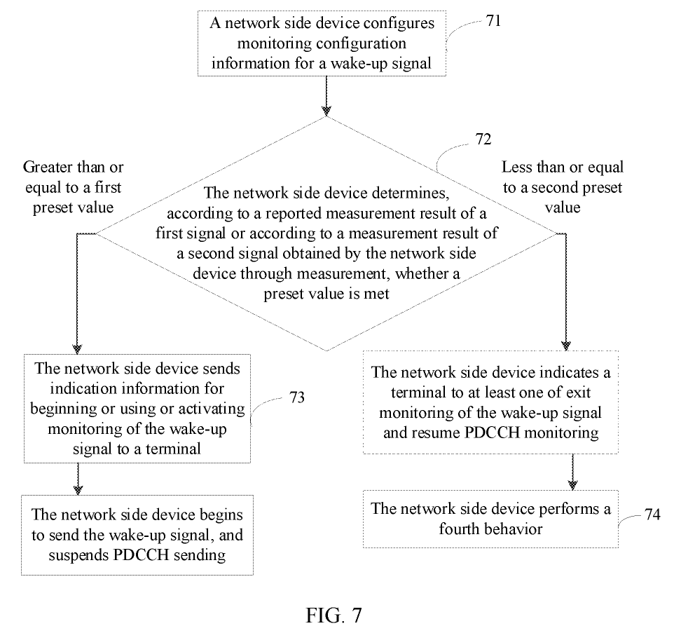

In some embodiments, a wake-up signal sending processing procedure of a network side device is shown in FIG. 7, and the following procedure is specifically included:

Step 71: A network side device configures monitoring configuration information for a wake-up signal.

Step 72: The network side device determines, according to a reported measurement result of a first signal or according to a measurement result of a second signal obtained by the network side device through measurement, whether a preset value is met. That is, after configuring the monitoring configuration information for the wake-up signal, the network side device needs to determine, according to a target measurement result (the measurement result of the first signal or the measurement result of the second signal), whether to begin to send the wake-up signal. In other words, after receiving the monitoring configuration information for the wake-up signal from the network side device, the terminal does not begin to perform WUS monitoring. When the terminal receives indication information indicating to begin or use or activate monitoring of the wake-up signal, the terminal begins to perform WUS monitoring.

It should be understood that, in some embodiments, after configuring the monitoring configuration information for the wake-up signal, the network side device begins to send the wake-up signal according to the monitoring configuration information. After receiving the monitoring configuration information for the wake-up signal from the network side device, the terminal begins to perform WUS monitoring.

In this embodiment of this application, when the network side device determines that the target measurement result is greater than or equal to a first preset value, step 73 is performed. When the network side device determines that the target measurement result is greater than or equal to a first preset value, step 74 is performed.

Step 73: The network side device sends the indication information for beginning or using or activating monitoring of the wake-up signal to the terminal. In addition, the network side device begins to send the wake-up signal, and suspends PDCCH sending.

Step 74: The network side device performs a fourth behavior, where the fourth behavior includes at least one of the following:

resuming PDCCH transmission;

stopping sending the wake-up signal to the terminal; and

deactivating or disabling the monitoring configuration information for the wake-up signal related to the terminal.

Optionally, before step 74, the procedure may further include: The network side device indicates the terminal to at least one of exit monitoring of the wake-up signal and resume PDCCH monitoring.

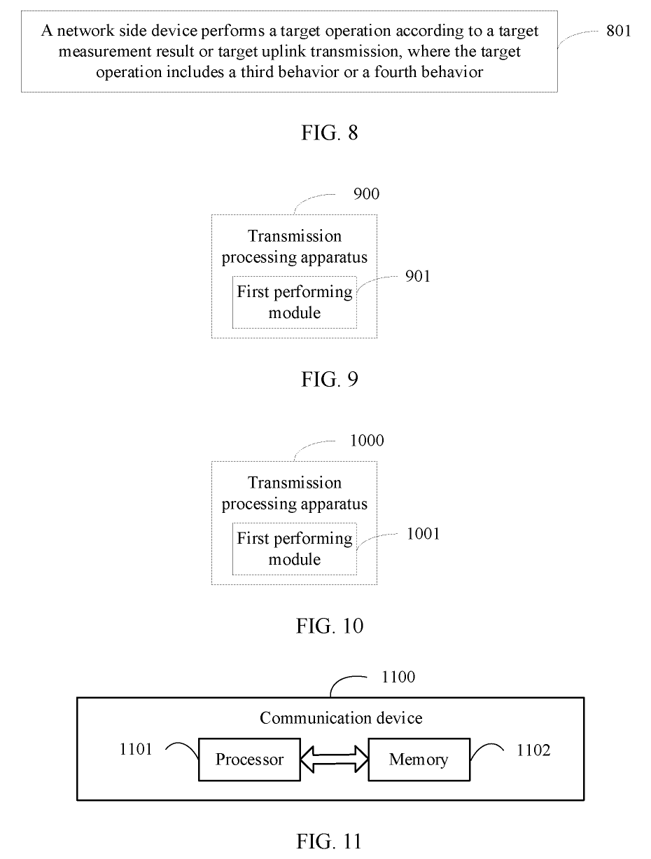

Refer to FIG. 8. This application further provides a transmission processing method. As shown in FIG. 8, the transmission processing method includes the following steps:

Step 801: A network side device performs a target operation according to a target measurement result or target uplink transmission, where the target operation includes a third behavior or a fourth behavior.

The target measurement result includes a measurement result of a first signal reported by a terminal, or a measurement result of a second signal obtained by the network side device through measurement, the third behavior includes at least one of beginning transmission of a wake-up signal and suspending transmission of target content, and the fourth behavior includes at least one of the following: suspending or stopping transmission of the wake-up signal and resuming transmission of the target content.

The target content includes at least one of a physical downlink control channel PDCCH, a physical downlink shared channel PDSCH, and a downlink reference signal.

Optionally, when the network side device performs the fourth behavior, the method further includes:

The network side device deactivates or disables a wake-up signal monitoring configuration associated with the wake-up signal.

Optionally, when the target content includes the PDCCH, resuming PDCCH transmission includes at least one of the following:

performing PDCCH transmission using a target discontinuous reception DRX configuration;

performing PDCCH transmission according to a target search space group; and

performing PDCCH transmission in an N^{th} time unit starting from a time unit in which the terminal receives the target uplink transmission, where N is a natural number.

Optionally, the target search space group may be any one of a default search space group configured by the network side device, and a search space group #0. The search space group is a specific search space set. The terminal can apply only one search space group at the same time.

Optionally, the target uplink transmission includes at least one of the following: first information or second information, a measurement report, and a target reference signal; and

the first information is used to request or inform at least one of the following: exiting monitoring of the wake-up signal and resuming monitoring of the target content; and the second information is used to request or inform at least one of the following: entering monitoring of the wake-up signal, and entering monitoring of the wake-up signal and do not monitoring the target content.

Optionally, the first information or the second information is carried based on at least one of the following: a scheduling request SR, a physical uplink control channel PUCCH, a configured grant physical uplink shared channel CG PUSCH, a buffer status report BSR, uplink control information UCI, channel state information CSI, and a physical random access channel PRACH.

Optionally, the target operation satisfies at least one of the following:

when the target measurement result is greater than or equal to a first preset value, performing the third behavior; and

when the target measurement result is less than or equal to a second preset value, performing the fourth behavior, where

the first preset value is greater than or equal to the second preset value.

Optionally, the method further includes at least one of the following:

The network side device sends the first signal to the terminal, and receives the measurement result of the first signal from the terminal.

The network side device measures the second signal sent by the terminal, and obtains the measurement result of the second signal.

Optionally, the first signal includes at least one of a synchronization signal block, a channel state information reference signal, a positioning reference signal, and a sounding reference signal.

Optionally, the measurement result of the first signal is a result of measurement performed by a main communication module of the terminal.

Optionally, the method further includes at least one of the following:

The network side device sends monitoring configuration information for the wake-up signal to the terminal.

The network side device sends indication information for beginning monitoring of the wake-up signal or indication information for activating monitoring of the wake-up signal to the terminal.

The transmission processing method provided in the embodiments of this application may be performed by a transmission processing apparatus. In the embodiments of this application, the transmission processing apparatus according to the embodiments of this application is described by using an example in which the transmission processing apparatus performs the transmission processing method.

Refer to FIG. 9. An embodiment of this application further provides a transmission processing apparatus. As shown in FIG. 9, the transmission processing apparatus 900 includes:

a first performing module 901, configured to perform at least one of a first operation and a second operation, where the first operation includes performing a first behavior or a second behavior according to a measurement result of a first signal, and the second operation includes performing the second behavior when a first timer expires; where

the first behavior includes entering monitoring of a wake-up signal, or entering monitoring of a wake-up signal and do not monitoring target content; the second behavior includes at least one of exiting monitoring of the wake-up signal and resuming monitoring of the target content; and the target content includes at least one of a physical downlink control channel PDCCH, a physical downlink shared channel PDSCH, and a downlink reference signal.

Optionally, when the target content includes the PDCCH, resuming PDCCH monitoring includes at least one of the following:

performing PDCCH monitoring by using a target discontinuous reception DRX configuration;

performing PDCCH monitoring according to a target search space group; and

performing PDCCH monitoring from N^{th} time unit starting from a time unit in which the terminal sends target uplink transmission, where N is a natural number, and the target uplink transmission is uplink information or an uplink signal.

Optionally, the target DRX configuration is in an activated state when the terminal performs the second behavior.

Optionally, the performing PDCCH monitoring by using a target discontinuous reception DRX configuration includes:

starting a second timer associated with the target DRX configuration, and performing, by the terminal, PDCCH monitoring during the running of the second timer.

Optionally, the transmission processing apparatus 900 further includes: a first sending module, configured to send target uplink transmission to a network side device when the first operation is performed, where the target uplink transmission is uplink information or an uplink signal, and the target uplink transmission includes at least one of the following: first information or second information, a measurement report, and a target reference signal; and

the first information is used to request or inform at least one of the following: exiting monitoring of the wake-up signal and resuming monitoring of the target content; and the second information is used to request or inform at least one of the following: entering monitoring of the wake-up signal, and entering monitoring of the wake-up signal and do not monitoring the target content.

Optionally, the first information or the second information is carried based on at least one of the following: a scheduling request SR, a physical uplink control channel PUCCH, a configured grant physical uplink shared channel CG PUSCH, a buffer status report BSR, uplink control information UCI, channel state information CSI, and a physical random access channel PRACH.

Optionally, the first operation satisfies at least one of the following:

when the measurement result of the first signal is greater than or equal to a first preset value, performing the first behavior; and

when the measurement result of the first signal is less than or equal to a second preset value, performing the second behavior, where

the first preset value is greater than or equal to the second preset value.

Optionally, the transmission processing apparatus 900 further includes: the first sending module, configured to send the measurement result of the first signal to the network side device.

Optionally, the first signal includes at least one of a synchronization signal block, a channel state information reference signal, a positioning reference signal, and a sounding reference signal.

Optionally, the first performing module 901 is further configured to measure the first signal by using a main communication module, and obtain the measurement result of the first signal.

Optionally, a start time for resuming monitoring of the target content is determined based on a time of exiting monitoring of the wake-up signal or a time of sending the first information to the network side device; where

the first information is used to request or inform at least one of the following: exiting monitoring of the wake-up signal and resuming monitoring of the target content.

Optionally, a start time for not monitoring the target content is determined based on a time of performing monitoring of the wake-up signal or a time of sending the second information to the network side device; where

the second information is used to request or inform at least one of the following: entering monitoring of the wake-up signal, and entering monitoring of the wake-up signal and do not monitoring the target content.

Optionally, the first performing module 901 is further configured to monitor the wake-up signal during the running of the first timer; or start the first timer when monitoring of the wake-up signal begins.

Optionally, the first performing module 901 is further configured to restart the first timer when the terminal detects the wake-up signal or detects a PDCCH monitoring skipping indication.

Optionally, the first performing module 901 is further configured to suspend or stop the first timer when the terminal detects the wake-up signal or detects the wake-up signal with wake-up indication.

Optionally, the first performing module 901 is further configured to suspend or stop running of the first timer when the terminal performs the second behavior.

Optionally, the first performing module 901 is further configured to:

receive monitoring configuration information for the wake-up signal from the network side device; and

receive indication information for beginning monitoring of the wake-up signal or indication information for activating monitoring of the wake-up signal from the network side device.

Refer to FIG. 10. An embodiment of this application further provides a transmission processing apparatus. As shown in FIG. 10, the transmission processing apparatus 1000 includes:

a second performing module 1001, configured to perform a target operation according to a target measurement result or target uplink transmission, where the target operation includes a third behavior or a fourth behavior;

the target measurement result includes a measurement result of a first signal reported by a terminal, or a measurement result of a second signal obtained by the network side device through measurement, the third behavior includes at least one of beginning transmission of a wake-up signal and suspending transmission of target content, and the fourth behavior includes at least one of the following: suspending or stopping transmission of the wake-up signal and resuming transmission of the target content; and

the target content includes at least one of a physical downlink control channel PDCCH, a physical downlink shared channel PDSCH, and a downlink reference signal.

Optionally, the second performing module 1001 is further configured to: when the fourth behavior is performed, deactivate or disable a wake-up signal monitoring configuration associated with the wake-up signal.

Optionally, when the target content includes the PDCCH, resuming PDCCH transmission includes at least one of the following:

performing PDCCH transmission using a target discontinuous reception DRX configuration;

performing PDCCH transmission according to a target search space group; and

performing PDCCH transmission in an N^{th} time unit starting from a time unit in which the terminal receives the target uplink transmission, where N is a natural number.

Optionally, the target uplink transmission includes at least one of the following: first information or second information, a measurement report, and a target reference signal; and

the first information is used to request or inform at least one of the following: exiting monitoring of the wake-up signal and resuming monitoring of the target content; and the second information is used to request or inform at least one of the following: entering monitoring of the wake-up signal, and entering monitoring of the wake-up signal and do not monitoring the target content.

Optionally, the first information or the second information is carried based on at least one of the following: a scheduling request SR, a physical uplink control channel PUCCH, a configured grant physical uplink shared channel CG PUSCH, a buffer status report BSR, uplink control information UCI, channel state information CSI, and a physical random access channel PRACH.

Optionally, the target operation satisfies at least one of the following:

when the target measurement result is greater than or equal to a first preset value, performing the third behavior; and

when the target measurement result is less than or equal to a second preset value, performing the fourth behavior, where

the first preset value is greater than or equal to the second preset value.

Optionally, the second performing module is further configured to perform at least one of the following:

send the first signal to the terminal, and receive the measurement result of the first signal from the terminal; and

measure the second signal sent by the terminal, and obtain the measurement result of the second signal.

Optionally, the first signal includes at least one of a synchronization signal block, a channel state information reference signal, a positioning reference signal, and a sounding reference signal.

Optionally, the measurement result of the first signal is a result of measurement performed by a main communication module of the terminal.

Optionally, the transmission processing apparatus further includes a second sending module, and the second sending module is configured to perform at least one of the following:

sending monitoring configuration information for the wake-up signal to the terminal; and

sending indication information for beginning monitoring of the wake-up signal or indication information for activating monitoring of the wake-up signal to the terminal.

The transmission processing apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a network attached storage (NAS), or the like. This is not specifically limited in this embodiment of this application.

The transmission processing apparatus provided in this embodiment of this application can implement the processes implemented in the method embodiments in FIG. 4 to FIG. 8, and achieve a same technical effect. To avoid repetition, details are not described herein again.

As shown in FIG. 11, an embodiment of this application further provides a communication device 1100, including a processor 1101 and a memory 1102. The memory 1102 stores a program or an instruction that is executable on the processor 1101. The program or the instruction is executed by the processor 1101 to implement the processes of the foregoing transmission processing method embodiments, and a same technical effect can be achieved. To avoid repetition, details are not described herein again.

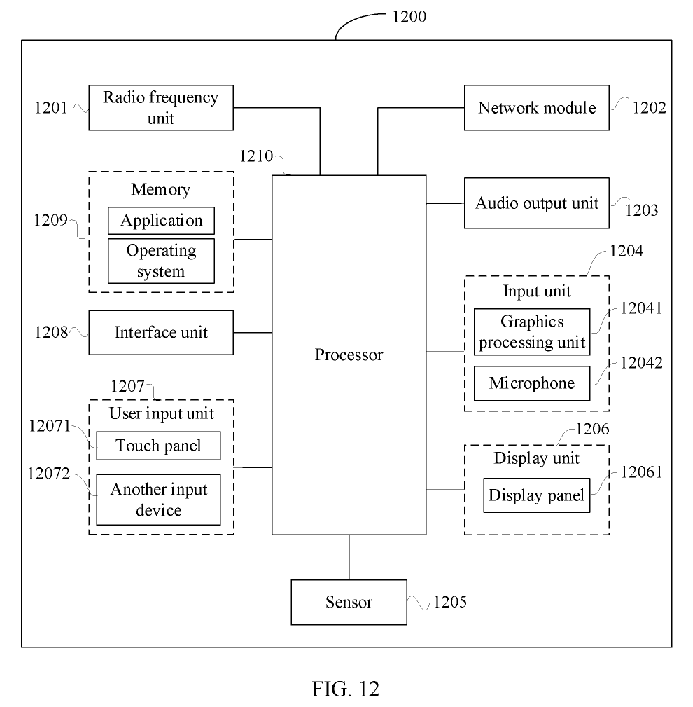

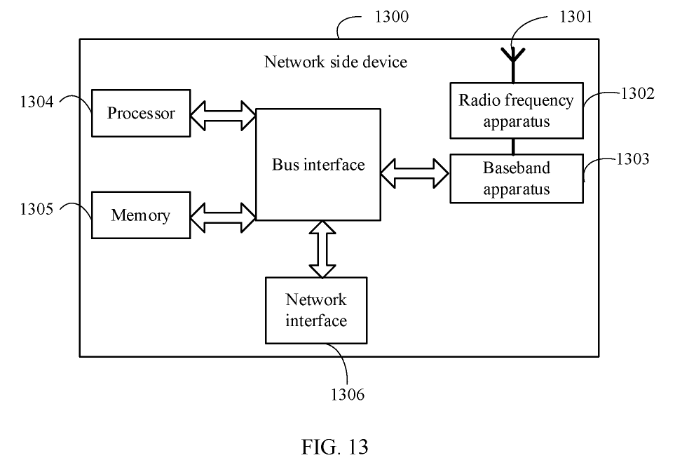

An embodiment of this application further provides a terminal, including a processor and a communication interface. The communication interface is coupled to the processor, and the processor is configured to run a program or an instruction to implement the steps in the method embodiment shown in FIG. 4. The terminal embodiment is corresponding to the method embodiment on the terminal side, each implementation process and implementation of the method embodiment can be applied to the terminal embodiment, and a same technical effect can be achieved. Specifically, FIG. 12 is a schematic diagram of a hardware structure of a terminal according to an embodiment of this application.

The terminal 1200 includes but is not limited to at least a part of components such as a radio frequency unit 1201, a network module 1202, an audio output unit 1203, an input unit 1204, a sensor 1205, a display unit 1206, a user input unit 1207, an interface unit 1208, a memory 1209, and a processor 1210.

A person skilled in the art can understand that the terminal 1200 may further include a power supply (such as a battery) that supplies power to each component. The power supply may be logically connected to the processor 1210 by using a power supply management system, to implement functions such as charging and discharging management, and power consumption management by using the power supply management system. The terminal structure shown in FIG. 12 constitutes no limitation on the terminal, and the terminal may include more or fewer components than those shown in the figure, or combine some components, or have different component arrangements. Details are not described herein.

It should be understood that, in this embodiment of this application, the input unit 1204 may include a graphics processing unit (GPU) 12041 and a microphone 12042, and the graphics processing unit 12041 processes image data of a still picture or a video obtained by an image capture apparatus (such as a camera) in a video capture mode or an image capture mode. The display unit 1206 may include a display panel 12061, and the display panel 12061 may be configured in a form of a liquid crystal display, an organic light-emitting diode, or the like. The user input unit 1207 includes at least one of a touch panel 12071 and another input device 12072. The touch panel 12071 is also referred to as a touchscreen. The touch panel 12071 may include two parts: a touch detection apparatus and a touch controller. The another input device 12072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1201 may transmit the downlink data to the processor 1210 for processing. In addition, the radio frequency unit 1201 may send uplink data to the network side device. Generally, the radio frequency unit 1201 includes but is not limited to an antenna, an amplifier, a transceiver, a coupler, a low noise amplifier, a duplexer, and the like.

The memory 1209 may be configured to store a software program or an instruction and various data. The memory 1209 may mainly include a first storage area for storing a program or an instruction and a second storage area for storing data. The first storage area may store an operating system, and an application or an instruction required by at least one function (for example, a sound playing function or an image playing function). In addition, the memory 1209 may include a volatile memory or a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 1209 in this embodiment of this application includes but is not limited to these memories and any memory of another proper type.

The processor 1210 may include one or more processing units. Optionally, an application processor and a modem processor are integrated into the processor 1210. The application processor mainly processes an operating system, a user interface, an application, or the like. The modem processor mainly processes a wireless communication signal, for example, a baseband processor. It may be understood that, alternatively, the modem processor may not be integrated into the processor 1210.

The radio frequency unit 1201 is configured to perform at least one of a first operation and a second operation, where the first operation includes performing a first behavior or a second behavior according to a measurement result of a first signal, and the second operation includes performing the second behavior when a first timer expires; where

the first behavior includes entering monitoring of a wake-up signal, or entering monitoring of a wake-up signal and do not monitoring target content; the second behavior includes at least one of exiting monitoring of the wake-up signal and resuming monitoring of the target content; and the target content includes at least one of a physical downlink control channel PDCCH, a physical downlink shared channel PDSCH, and a downlink reference signal.

It may be understood that for the implementation processes of the implementations mentioned in this embodiment, refer to the related descriptions of the method embodiment on the terminal side. A same or corresponding technical effect is achieved. To avoid repetition, details are not described herein again.

An embodiment of this application further provides a network side device, including a processor and a communication interface. The communication interface is coupled to the processor, and the processor is configured to run a program or an instruction to implement the steps in the method embodiment shown in FIG. 8. The network side device embodiment corresponds to the method embodiment of the network side device, each implementation process and implementation of the method embodiment can be applied to the network side device embodiment, and a same technical effect can be achieved.

Specifically, an embodiment of this application further provides a network side device. As shown in FIG. 13, the network side device 1300 includes an antenna 1301, a radio frequency apparatus 1302, a baseband apparatus 1303, a processor 1304, and a memory 1305. The antenna 1301 is connected to the radio frequency apparatus 1302. In an uplink direction, the radio frequency apparatus 1302 receives information through the antenna 1301, and sends the received information to the baseband apparatus 1303 for processing. In a downlink direction, the baseband apparatus 1303 processes information that needs to be sent, and sends processed information to the radio frequency apparatus 1302. The radio frequency apparatus 1302 processes the received information, and sends processed information through the antenna 1301.

In the foregoing embodiment, the method performed by the network side device may be implemented in the baseband apparatus 1303. The baseband apparatus 1303 includes a baseband processor.

For example, the baseband apparatus 1303 may include at least one baseband board. A plurality of chips are disposed on the baseband board. As shown in FIG. 13, one chip is, for example, a baseband processor, and is connected to the memory 1305 by using a bus interface, to invoke a program in the memory 1305 to perform the operations of the network device shown in the foregoing method embodiment.

The network side device may further include a network interface 1306, and the interface is, for example, a common public radio interface (CPRI).

Specifically, the network side device 1300 in this embodiment of this application further includes an instruction or a program that is stored in the memory 1305 and that is executable on the processor 1304. The processor 1304 invokes the instruction or the program in the memory 1305 to execute the method executed by the modules shown in FIG. 10, and a same technical effect is achieved. To avoid repetition, details are not described herein again.

An embodiment of this application further provides a readable storage medium. The readable storage medium stores a program or an instruction, and the program or the instruction is executed by a processor to implement the processes of the foregoing transmission processing method embodiment, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc. In some examples, the readable storage medium may be a non-transitory readable storage medium.

An embodiment of this application still provides a chip. The chip includes a processor and a communications interface, and the communications interface is coupled to the processor. The processor is configured to run a program or an instruction, to implement various processes of the foregoing embodiments of the transmission processing method, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, and the program/program product is executed by at least one processor to implement the processes of the foregoing transmission processing method embodiment, and a same technical effect can be achieved. To avoid repetition, details are not described herein again.

An embodiment of this application further provides a wireless communication system, including a terminal and a network side device. The terminal may be configured to perform the steps of the foregoing transmission processing method on the terminal side, and the network side device may be configured to perform the steps of the foregoing transmission processing method on the network device side.

It should be noted that, in this specification, the term "include", "comprise", or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by "includes a..." does not preclude the existence of other identical elements in the process, method, article, or apparatus that includes the element. In addition, it should be noted that the scope of the method and apparatuses in the embodiments of this application is not limited to performing functions in the order shown or discussed, but may also include performing the functions in a basically simultaneous manner or in opposite order based on the functions involved. For example, the described method may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by a computer software product in addition to a necessary universal hardware platform or by hardware only. The computer software product is stored in a storage medium (such as a ROM, a RAM, a magnetic disk, or an optical disc), and includes several instructions for instructing a terminal or a network side device to perform the methods in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make implementations in many forms without departing from the purpose of this application and the protection scope of the claims, the implementations fall within the protection of this application.

1. A transmission processing method, comprising:
performing, by a terminal, at least one of a first operation and a second operation, wherein the first operation comprises performing a first behavior or a second behavior according to a measurement result of a first signal, and the second operation comprises performing the second behavior when a first timer expires; wherein
the first behavior comprises entering monitoring of a wake-up signal, or entering monitoring of a wake-up signal and do not monitoring target content; the second behavior comprises at least one of exiting monitoring of the wake-up signal and resuming monitoring of the target content; and the target content comprises at least one of a physical downlink control channel PDCCH, a physical downlink shared channel PDSCH, and a downlink reference signal.

2. The method according to claim 1, wherein when the target content comprises the PDCCH, resuming PDCCH monitoring comprises at least one of the following:
performing PDCCH monitoring by using a target discontinuous reception DRX configuration;
performing PDCCH monitoring according to a target search space group; and
performing PDCCH monitoring from a N^{th} time unit starting from a time unit in which the terminal sends target uplink transmission, wherein N is a natural number, and the target uplink transmission is uplink information or an uplink signal.

3. The method according to claim 2, wherein the target DRX configuration is in an activated state when the terminal performs the second behavior.

4. The method according to claim 2, wherein the performing PDCCH monitoring by using a target discontinuous reception DRX configuration comprises:
starting a second timer associated with the target DRX configuration, and performing, by the terminal, PDCCH monitoring during the running of the second timer.

5. The method according to claim 1, wherein when the terminal performs the first operation, the method further comprises:
sending, by the terminal, target uplink transmission to a network side device, wherein the target uplink transmission is uplink information or an uplink signal, and the target uplink transmission comprises at least one of the following: first information or second information, a measurement report, and a target reference signal; and
the first information is used to request or inform at least one of the following: exiting monitoring of the wake-up signal and resuming monitoring of the target content; and the second information is used to request or inform at least one of the following: entering monitoring of the wake-up signal, and entering monitoring of the wake-up signal and do not monitoring the target content.

6. The method according to claim 5, wherein the first information or the second information is carried based on at least one of the following: a scheduling request SR, a physical uplink control channel PUCCH, a configured grant physical uplink shared channel CG PUSCH, a buffer status report BSR, uplink control information UCI, channel state information CSI, and a physical random access channel PRACH.

7. The method according to claim 1, wherein the first operation satisfies at least one of the following:
when the measurement result of the first signal is greater than or equal to a first preset value, performing the first behavior; and
when the measurement result of the first signal is less than or equal to a second preset value, performing the second behavior, wherein
the first preset value is greater than or equal to the second preset value.

8. The method according to claim 1, wherein the method further comprises at least one of the following:
sending, by the terminal, the measurement result of the first signal to the network side device;
measuring, by the terminal, the first signal by using a main communication module, and obtaining the measurement result of the first signal;
monitoring, by the terminal, the wake-up signal during the running of the first timer; or
starting, by the terminal, the first timer when the terminal begins to monitor the wake-up signal.

9. The method according to claim 1, wherein the first signal comprises at least one of a synchronization signal block, a channel state information reference signal, a positioning reference signal, and a sounding reference signal.

10. The method according to claim 1, wherein a start time of resuming monitoring of the target content is determined based on a time of exiting monitoring of the wake-up signal or a time of sending the first information to the network side device; wherein
the first information is used to request or inform at least one of the following: exiting monitoring of the wake-up signal and resuming monitoring of the target content.

11. The method according to claim 1, wherein a start time of not monitoring the target content is determined based on a time of performing monitoring of the wake-up signal or a time of sending the second information to the network side device; wherein
the second information is used to request or inform at least one of the following: entering monitoring of the wake-up signal, and entering monitoring of the wake-up signal and do not monitoring the target content.

12. The method according to claim 1, wherein the method further comprises at least one of the following:
restarting, by the terminal, the first timer when the terminal detects the wake-up signal or detects a PDCCH monitoring skipping indication;
suspending or stopping, by the terminal, the first timer when the terminal detects the wake-up signal or detects the wake-up signal with wake-up indication; or
suspending or stopping, by the terminal, running of the first timer when the terminal performs the second behavior.

13. The method according to claim 1, wherein before the terminal performs at least one of the first operation and the second operation, the method further comprises at least one of the following:
receiving, by the terminal, monitoring configuration information for the wake-up signal from the network side device; and
receiving, by the terminal, indication information for beginning monitoring of the wake-up signal or indication information for activating monitoring of the wake-up signal from the network side device.

14. A transmission processing method, comprising:
performing, by a network side device, a target operation according to a target measurement result or target uplink transmission, wherein the target operation comprises a third behavior or a fourth behavior;
the target measurement result comprises a measurement result of a first signal reported by a terminal, or a measurement result of a second signal obtained by the network side device through measurement, the third behavior comprises at least one of beginning transmission of a wake-up signal and suspending transmission of target content, and the fourth behavior comprises at least one of the following: suspending or stopping transmission of the wake-up signal and resuming transmission of the target content; and
the target content comprises at least one of a physical downlink control channel PDCCH, a physical downlink shared channel PDSCH, and a downlink reference signal.

15. The method according to claim 14, wherein when the network side device performs the fourth behavior, the method further comprises:
deactivating or disabling, by the network side device, a wake-up signal monitoring configuration associated with the wake-up signal.

16. The method according to claim 14, wherein when the target content comprises the PDCCH, resuming PDCCH transmission comprises at least one of the following:
performing PDCCH transmission using a target discontinuous reception DRX configuration;
performing PDCCH transmission according to a target search space group; and
performing PDCCH transmission in a N^{th} time unit starting from a time unit in which the terminal receives the target uplink transmission, wherein N is a natural number.

17. The method according to claim 14, wherein the target uplink transmission comprises at least one of the following: first information or second information, a measurement report, and a target reference signal; and
the first information is used to request or inform at least one of the following: exiting monitoring of the wake-up signal and resuming monitoring of the target content; and the second information is used to request or inform at least one of the following: entering monitoring of the wake-up signal, and entering monitoring of the wake-up signal and do not monitoring the target content.

18. The method according to claim 17, wherein the first information or the second information is carried based on at least one of the following: a scheduling request SR, a physical uplink control channel PUCCH, a configured grant physical uplink shared channel CG PUSCH, a buffer status report BSR, uplink control information UCI, channel state information CSI, and a physical random access channel PRACH.

19. A terminal, comprising at least one hardware processor and a memory, wherein the memory stores a program or an instruction that is executable on the at least one hardware processor, and the program or the instruction is executed by the at least one hardware processor to cause the terminal to:
perform at least one of a first operation and a second operation, wherein the first operation comprises performing a first behavior or a second behavior according to a measurement result of a first signal, and the second operation comprises performing the second behavior when a first timer expires; wherein
the first behavior comprises entering monitoring of a wake-up signal, or entering monitoring of a wake-up signal and do not monitoring target content; the second behavior comprises at least one of exiting monitoring of the wake-up signal and resuming monitoring of the target content; and the target content comprises at least one of a physical downlink control channel PDCCH, a physical downlink shared channel PDSCH, and a downlink reference signal.

20. A network side device, comprising at least one hardware processor and a memory, wherein the memory stores a program or an instruction that is executable on the at least one hardware processor, and the program or the instruction is executed by the at least one hardware processor to implement the transmission processing method according to claim 14.
